(19) United States
(12) Patent Application Publication
(10) Pub. No.: US 2022/0306472 A1
(43) Pub. Date: Sep. 29, 2022

(54) ORTHOPHOSPHATE THERMAL BARRIER COATING MATERIAL WITH HIGH COEFFICIENT OF THERMAL EXPANSION AND PREPARATION METHOD THEREOF

(71) Applicant: Shandong University, Jinan City (CN)

(72) Inventors: Fapeng YU, Jinan City (CN); Guangda Wu, Jinan City (CN); Mengdi Fan, Jinan City (CN); Tingwei Chen, Jinan City (CN); Xiufeng Cheng, Jinan City (CN); Xian Zhao, Jinan City (CN)

(73) Assignee: Shandong University, Jinan City (CN)

(21) Appl. No.: 17/701,770

(22) Filed: Mar. 23, 2022

(30) Foreign Application Priority Data
Mar. 24, 2021 (CN) 202110314700.8

(51) Int. Cl. C01B 25/45; C09D 1/00; C04B 35/447; C04B 35/626; C04B 35/64

(52) U.S. Cl. CPC C01B 25/45; C09D 1/00; C04B 35/447; C04B 35/62655; C04B 35/62635; C04B 35/64; C04B 2235/9607; C04B 2235/606; C04B 2235/762

(57) ABSTRACT

The present disclosure relates to an orthophosphate thermal barrier coating material with high coefficient of thermal expansion and a preparation method thereof. ReM₃P₃O₁₂ series ceramics with an eulytite crystal structure are prepared by a high-temperature solid-phase reaction for the first time. The ReM₃P₃O₁₂ ceramic belongs to a −43 m space group of a cubic crystal system, which not only has a higher melting point and excellent high-temperature phase stability, but also has a lower thermal conductivity and a suitable coefficient of thermal expansion. It can effectively alleviate the stress caused by the mismatch of the coefficient of thermal expansion of the base material and the ceramic layer, so as to meet the requirements of thermal insulation and high-temperature oxidation and corrosion resistance of the hot end parts in long-term service, which has application prospects in the field of thermal barrier coatings.

### CROSS REFERENCE TO RELATED APPLICATION

This patent application claims the benefit and priority of Chinese Patent Application No. 202110314700.8 filed on Mar. 24, 2021, the disclosure of which is incorporated by reference herein in its entirety as part of the present application.

### TECHNICAL FIELD

The present disclosure relates to an orthophosphate thermal barrier coating material with high coefficient of thermal expansion and a preparation method thereof, and belongs to the technical field of thermal barrier coatings.

### BACKGROUND ART

Thermal barrier coatings are commonly applied to superalloy components in aircraft engines to protect them from high-temperature combustion, allowing modern engines to operate at higher gas temperatures, which can improve energy conversion efficiency and reduce harmful emissions. The thermal barrier coating on the outermost surface requires good thermal properties, such as high melting point, low thermal conductivity, high temperature phase stability and sintering resistance; at the same time, it also requires matching coefficients of thermal expansion. There are many types of thermal barrier coating materials. Currently, the widely used thermal barrier coating materials mainly include yttria stabilized zirconia (YSZ) and rare earth zirconate (RE₂Zr₂O₇). However, the current thermal barrier coating materials all have some deficiencies: YSZ will undergo high-temperature phase transition above 1200° C., and the thermal conductivity is relatively high; while the rare earth zirconate has a low coefficient of thermal expansion, which will generate greater thermal stress during thermal cycling, and the concentration of stress will lead to the cracking and peeling of the coating. Therefore, the development of new thermal barrier coating materials has become a key issue for the development of the next generation of high-performance aircraft engines.

Chinese patent application CN110386595A discloses a high-entropy rare earth phosphoric acid powder and a preparation method thereof. The high-entropy rare earth phosphate powder has a chemical formula of (La_{0.2}Ce_{0.2}Nd_{0.2}Sm_{0.2}Eu_{0.2})PO₄, (La_{0.2}Y_{0.2}Nd_{0.2}Sm_{0.2}Eu_{0.2})PO₄, (La_{0.2}Y_{0.2}Nd_{0.2}Yb_{0.2}Eu_{0.2})PO₄ or (La_{0.2}Ce_{0.2}Y_{0.2}Yb_{0.2}Er_{0.2})PO₄, which can be used as Al₂O_{3f}/A₁₂O₃ composite thermal barrier/environmental barrier coating material, and can also be used as high temperature insulation material; the preparation method provided by the patent application has simple process and low calcination temperature; however, the thermal conductivity of the rare earth phosphoric acid powder at room temperature is relatively high, the thermal conductivity at room temperature is 2.03-2.06 W/m·K, and the coefficient of thermal expansion is too low, only 8.5-9.0×10⁻⁶/° C. (300-1300° C.).

Chinese patent application CN112063959A discloses a thermal barrier coating with a column-layer/tree composite structure, which includes a columnar structure layer inside and a layer/tree composite structure layer outside; the layer/tree composite structure layer outside includes N layers of micro-nano composite layer-shaped structures; a layer of a tree-shaped structure is provided between two adjacent layers of micro-nano composite layer-shaped structures, where N is a natural number, and is more than or equal to 2; each micro-nano composite layer-shaped structure consists of a sheet layer unit and a plurality of nanocluster accumulation units which are randomly distributed therein; the thickness of the columnar structure layer accounts for 40%-60% of the total thickness of the thermal barrier coating, and the thickness of each layer of the tree-shaped structure in the layer/tree composite structure layer is less than or equal to 15% of the columnar structure layer. The thermal barrier coating has a complicated structure and is not easy to implement, and no specific performance is involved.

### SUMMARY

Aiming at the deficiencies of the prior art, the present disclosure provides an orthophosphate thermal barrier coating material with high coefficient of thermal expansion and a preparation method thereof.

### SUMMARY OF THE PRESENT DISCLOSURE

In the present disclosure, ReM₃P₃O₁₂ series ceramics with an eulytite crystal structure are prepared by a high-temperature solid-phase reaction for the first time. The ReM₃P₃O₁₂ ceramic belongs to a −43 m space group of a cubic crystal system, which not only has a higher melting point and excellent high-temperature phase stability, but also has a lower thermal conductivity and a suitable coefficient of thermal expansion. It can effectively alleviate the stress caused by the mismatch of the coefficient of thermal expansion of the base material and the ceramic layer, so as to meet the requirements of thermal insulation and high-temperature oxidation and corrosion resistance of the hot end parts in long-term service, which has application prospects in the field of thermal barrier coatings.

### DETAILED DESCRIPTION

An orthophosphate thermal barrier coating material with high coefficient of thermal expansion, having a general chemical formula of ReM₃P₃O₁₂, which belongs to a −43 m space group of a cubic crystal system with an eulytite crystal structure, wherein Re is a rare earth element, and M is an alkaline earth metal.

In some embodiments of the present disclosure, Re is one or two or a combination of more than two of Y, La, Nd, Sm, Gd, Dy, Ho, Er or Yb.

In some embodiments of the present disclosure, M is one or two or a combination of more than two of Sr, Ca or Ba.

In some embodiments of the present disclosure, the thermal barrier coating material ReM₃P₃O₁₂ with high coefficient of thermal expansion is selected from one of the followings:

NdBa₃P₃O₁₂, GdBa₃P₃O₁₂, DyBa₃P₃O₁₂, HoBa₃P₃O₁₂, or ErBa₃P₃O₁₂.

The present disclosure also provides a method for preparing the orthophosphate thermal barrier coating material with high coefficient of thermal expansion.

A method for preparing the orthophosphate thermal barrier coating material with high coefficient of thermal expansion, wherein comprising the following steps:

(1) Mixing a rare earth oxide, an alkaline earth metal-containing compound and a P-containing compound uniformly according to a molar ratio of 1:(4-8):(4-8), placing in a muffle furnace, heating up to 1000° C.-1100° C., and maintaining a constant temperature to perform a first sintering for 4-6 h to obtain a pre-sintered raw material;

(2) Grinding and pressing the pre-sintered raw material, placing in the muffle furnace, heating up to 1300° C.-1500° C., and performing a second sintering to obtain a pure phase material;

(3) Adding the pure phase material to absolute ethanol, ball milling for 20-30 h using a wet ball milling method, and then drying; grinding, sieving, and pressing into a green body;

(4) Placing the green body in the muffle furnace, heating up to 1500° C.-1700° C., performing a high-temperature reaction in an air atmosphere, and cooling down with the furnace after the reaction is completed to obtain an orthophosphate thermal barrier coating material with high coefficient of thermal expansion.

In some embodiments of the present disclosure, in step (1), the molar ratio of the rare earth oxide, the alkaline earth metal-containing compound and the P-containing compound is 1:6:6.

In some embodiments of the present disclosure, in step (1), the rare earth oxide is one or two or a combination of more than two of Y₂O₃, La₂O₃, Nd₂O₃, Sm₂O₃, Gd₂O₃, Dy₂O₃, Ho₂O₃, Er₂O₃ or Yb₂O₃.

In some embodiments of the present disclosure, in step (1), the purity of the rare earth oxide is greater than 99.99%.

In some embodiments of the present disclosure, in step (1), the alkaline earth metal-containing compound is one or two or a combination of more than two of BaCO₃ or SrCO₃ or BaCO₃.

In some embodiments of the present disclosure, in step (1), the P-containing compound is ammonium dihydrogen phosphate.

In some embodiments of the present disclosure, in step (1), the particle sizes of rare earth oxides, carbonates, and ammonium dihydrogen phosphate are 50-100 sm.

In some embodiments of the present disclosure, in step (1), the first sintering temperature is 1000° C., the time for maintaining the constant temperature is 5 h, so as to remove CO₂, NH₃ and H₂O in raw materials.

In some embodiments of the present disclosure, in step (1), the heating rate of the first sintering is 8-12° C./min.

In some embodiments of the present disclosure, in step (2), the second sintering temperature is 1400° C., the time for maintaining the constant temperature is 5 h.

In some embodiments of the present disclosure, in step (2), the heating rate of the second sintering is 8-12° C./min.

In some embodiments of the present disclosure, in step (3), the mass ratio of the added amount of absolute ethanol to the pure phase material is 1: (2-6).

In some embodiments of the present disclosure, in step (3), the pressure for pressing into a green body is 200-350 MPa.

In some embodiments of the present disclosure, in step (4), the high-temperature reaction temperature is 1600-1700° C., the heating rate is 1-3° C./min.

In some embodiments of the present disclosure, in step (4), the high-temperature reaction time is more than or equal to 5 h;

In some embodiments of the present disclosure, in step (4), the high-temperature reaction time is 8-20 h.

The technical characteristics and advantages of the present disclosure are as follows:

The orthophosphate material ReM₃P₃O₁₂ provided by the present disclosure has more vacancies and a more complicated cell structure than YSZ, and contains larger-mass rare earth atoms, which can greatly increase the scattering of phonons, thereby making the thermal conductivity lower than that of YSZ. In addition, the material has a high coefficient of thermal expansion, which can effectively relieve the stress caused by the mismatch between the coefficient of thermal expansion of the base material and the ceramic layer; at the same time, the orthophosphate material provided by the present disclosure has better high temperature stability and excellent chemical stability than YSZ. Therefore, the orthophosphate material provided by the present disclosure is a new thermal barrier coating material with important application prospects.

The ReM₃P₃O₁₂ material prepared by the present disclosure has a low thermal conductivity (0.77 W/m·K-0.95 W/m·K @ 25° C.), a hardness of 7 GPa-11 GPa, a high coefficient of thermal expansion (18×10⁻⁶-22×10⁻⁶/° C., 1000° C.), and has an excellent chemical and thermal stability, which is a potential candidate for thermal barrier coatings.

### BRIEF DESCRIPTION OF THE DRAWINGS

1401 FIG. 1 is an XRD pattern of the thermal barrier coating material ReM₃P₃O₁₂ of Examples 1-5;

FIG. 2 shows the hardness of the thermal barrier coating material ReM₃P₃O₁₂ of Examples 1-5;

FIG. 3 shows the modulus of elasticity of the thermal barrier coating material ReM₃P₃O₁₂ of Examples 1-5;

FIG. 4 is a TG-DTA curve of the thermal barrier coating material ReM₃P₃O₁₂ of Examples 1-5; a is NdBP material, b is GdBP material, c is DyBP material, d is HoBP material, and e is ErBP material.

FIG. 5 shows a temperature dependence of coefficient of thermal expansion of the thermal barrier coating material ReM₃P₃O₁₂ of Examples 1-5;

FIG. 6 shows a temperature dependence of thermal conductivity of the thermal barrier coating material ReM₃P₃P₁₂ of Examples 1-5.

### DETAILED DESCRIPTION OF THE EMBODIMENTS

1461 The present disclosure is further illustrated in conjunction with examples and drawings, but is not limited thereto.

### Example 1

NdBa₃P₃O₁₂ was prepared by cerium oxide, barium carbonate and ammonium dihydrogen phosphate, steps are as follows:

(1) Nd₂O₃, BaCO₃ and NH₄H₂PO₄ were taken as raw materials and mixed according to the molar ratio of 1:6:6;

(2) The raw materials prepared in step (1) were mixed uniformly and placed into an alumina crucible, then placed in a muffle furnace for a first sintering, the sintering temperature was 1000±50° C., the temperature was maintained for 5 h to remove the CO₂, NH₃ and H₂O in the raw materials to obtain a pre-sintered raw material;

(3) The pre-sintered raw material in step (2) was ground, pressed into a rod shape, and placed in the muffle furnace for a second sintering at a sintering temperature of 1400° C. to obtain a pure phase material;

(4) The pure phase material was added to absolute ethanol and ball milled for 48 h, the mass ratio of the added amount of absolute ethanol to the pure phase material was 1:3, and then dried;

(5) The powder in step (4) was fully ground, sieved (200 mesh), and pressed into a green body under 300 MPa;

(6) The green body was placed into the muffle furnace, heated up to 1600° C., subjected to a high-temperature reaction in an air atmosphere for 10 h, and then cooled down with the furnace;

(7) The reactant after cooling was taken out to obtain a material with a chemical formula of NdBa₃P₃O₁₂ (abbreviation: NdBP).

The prepared product has a thermal conductivity at room temperature of 0.95 W/m·K, a coefficient of thermal expansion of 21.6×10⁻⁶/° C. (1000° C.), a hardness of 7.4 GPa, and a modulus of elasticity of 90 GPa.

### Example 2

GdBa₃P₃O₁₂ was prepared by gadolinium oxide, barium carbonate and ammonium dihydrogen phosphate, steps are as follows:

(1) Gd₂O₃, BaCO₃ and NH₄H₂PO₄ were taken as raw materials and mixed according to the molar ratio of 1:6:6;

(2) The raw materials prepared in step (1) were mixed uniformly and placed into an alumina crucible, then placed in a muffle furnace for a first sintering, the sintering temperature was 1000±50° C., the temperature was maintained for 5 h to remove the CO₂, NH₃ and H₂O in the raw materials to obtain a pre-sintered raw material;

(3) The pre-sintered raw material in step (2) was ground, pressed into a rod shape, and placed in the muffle furnace for a second sintering at a sintering temperature of 1400° C. to obtain a pure phase material;

(4) The pure phase material was added to absolute ethanol and ball milled for 48 h, the mass ratio of the added amount of absolute ethanol to the pure phase material was 1:3, and then dried;

(5) The powder in step (4) was fully ground, sieved (200 mesh), and pressed into a green body under 300 MPa;

(6) The green body was placed into the muffle furnace, heated up to 1600° C., subjected to a high-temperature reaction in an air atmosphere for 10 h, and then cooled down with the furnace;

(7) The reactant after cooling was taken out to obtain a material with a chemical formula of GdBa₃P₃O₁₂ (abbreviation: GdBP).

The prepared product has a thermal conductivity at room temperature of 0.78 W/m·K, a coefficient of thermal expansion of 20.5×10⁻⁶/° C. (1000° C.), a hardness of 7.7 GPa, and a modulus of elasticity of 105 GPa.

### Example 3

DyBa₃P₃O₁₂ was prepared by dysprosium oxide, barium carbonate and ammonium dihydrogen phosphate, steps are as follows:

(1) Dy₂O₃, BaCO₃ and NH₄H₂PO₄ were taken as raw materials and mixed according to the molar ratio of 1:6:6;

(2) The raw materials prepared in step (1) were mixed uniformly and placed into an alumina crucible, then placed in a muffle furnace for a first sintering, the sintering temperature was 1000±50° C., the temperature was maintained for 5 h to remove the CO₂, NH₃ and H₂O in the raw materials to obtain a pre-sintered raw material;

(3) The pre-sintered raw material in step (2) was ground, pressed into a rod shape, and placed in the muffle furnace for a second sintering at a sintering temperature of 1400° C. to obtain a pure phase material;

(4) The pure phase material was added to absolute ethanol and ball milled for 48 h, the mass ratio of the added amount of absolute ethanol to the pure phase material was 1:3, and then dried;

(5) The powder in step (4) was fully ground, sieved (200 mesh), and pressed into a green body under 300 MPa;

(6) The green body was placed into the muffle furnace, heated up to 1600° C., subjected to a high-temperature reaction in an air atmosphere for 10 h, and then cooled down with the furnace;

(7) The reactant after cooling was taken out to obtain a material with a chemical formula of DyBa₃P₃O₁₂ (abbreviation: DyBP).

The prepared product has a thermal conductivity at room temperature of 0.83 W/m·K, a coefficient of thermal expansion of 19.8×10⁻⁶/° C. (1000° C.), a hardness of 8.2 GPa, and a modulus of elasticity of 100 GPa.

### Example 4

HoBa₃P₃O₁₂ was prepared by holmium oxide, barium carbonate and ammonium dihydrogen phosphate, steps are as follows:

(1) Ho₂O₃, BaCO₃ and NH₄H₂PO₄ were taken as raw materials and mixed according to the molar ratio of 1:6:6;

(2) The raw materials prepared in step (1) were mixed uniformly and placed into an alumina crucible, then placed in a muffle furnace for a first sintering, the sintering temperature was 1000±50° C., the temperature was maintained for 5 h to remove the CO₂, NH₃ and H₂O in the raw materials to obtain a pre-sintered raw material;

(3) The pre-sintered raw material in step (2) was ground, pressed into a rod shape, and placed in the muffle furnace for a second sintering at a sintering temperature of 1400° C. to obtain a pure phase material;

(4) The pure phase material was added to absolute ethanol and ball milled for 48 h, the mass ratio of the added amount of absolute ethanol to the pure phase material was 1:3, and then dried;

(5) The powder in step (4) was fully ground, sieved (200 mesh), and pressed into a green body under 300 MPa;

(6) The green body was placed into the muffle furnace, heated up to 1600° C., subjected to a high-temperature reaction in an air atmosphere for 10 h, and then cooled down with the furnace;

(7) The reactant after cooling was taken out to obtain a material with a chemical formula of HoBa₃P₃O_{z}(abbreviation: HoBP).

The prepared product has a thermal conductivity at room temperature of 0.87 W/m·K, a coefficient of thermal expansion of 19.2×10⁻⁶/° C. (1000° C.), a hardness of 10.6 GPa, and a modulus of elasticity of 111 GPa.

### Example 5

ErBa₃P₃O_{z} was prepared by erbium oxide, barium carbonate and ammonium dihydrogen phosphate, steps are as follows:

(1) Er₂O₃, BaCO₃ and NH₄H₂PO₄ were taken as raw materials and mixed according to the molar ratio of 1:6:6;

(2) The raw materials prepared in step (1) were mixed uniformly and placed into an alumina crucible, then placed in a muffle furnace for a first sintering, the sintering temperature was 1000±50° C., the temperature was maintained for 5 h to remove the CO₂, NH₃ and H₂O in the raw materials to obtain a pre-sintered raw material;

(3) The pre-sintered raw material in step (2) was ground, pressed into a rod shape, and placed in the muffle furnace for a second sintering at a sintering temperature of 1400° C. to obtain a pure phase material;

(4) The pure phase material was added to absolute ethanol and ball milled for 48 h, the mass ratio of the added amount of absolute ethanol to the pure phase material was 1:3, and then dried;

(5) The powder in step (4) was fully ground, sieved (200 mesh), and pressed into a green body under 300 MPa;

(6) The green body was placed into the muffle furnace, heated up to 1600° C., subjected to a high-temperature reaction in an air atmosphere for 10 h, and then cooled down with the furnace;

(7) The reactant after cooling was taken out to obtain a material with a chemical formula of ErBa₃P₃O₁₂ (abbreviation: ErBP).

The prepared product has a thermal conductivity at room temperature of 0.77 W/m·K, a coefficient of thermal expansion of 18.2×10⁻⁶/° C. (1000° C.), a hardness of 9.3 GPa, and a modulus of elasticity of 107 GPa.

### Experimental Example

1. The thermal barrier coating materials ReM₃P₃O_{z} of Examples 1-5 were subjected to XRD testing, and the results are shown in FIG. 1.

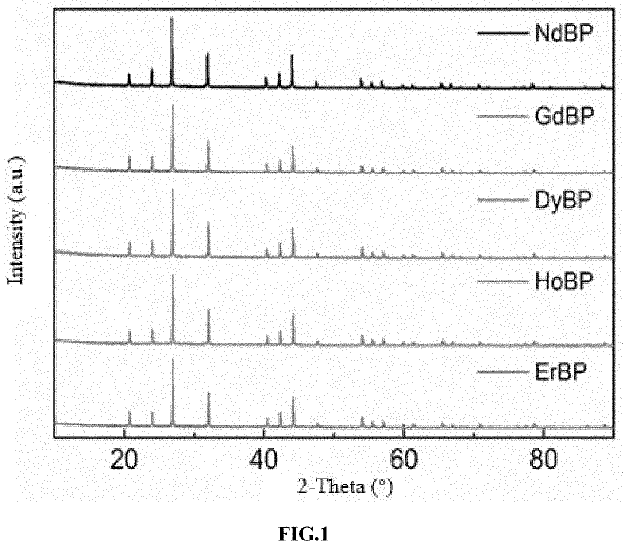

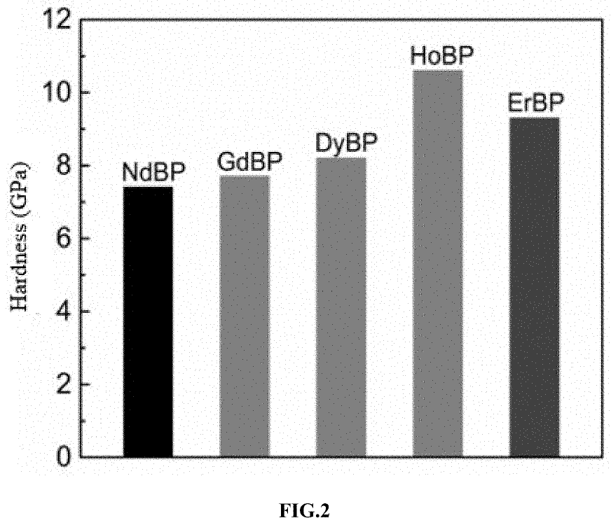

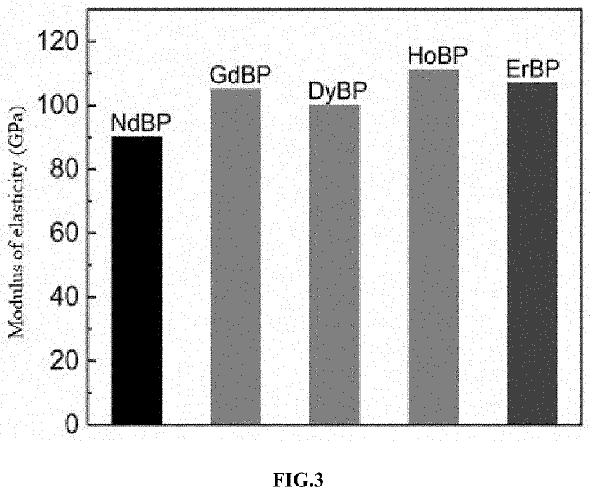

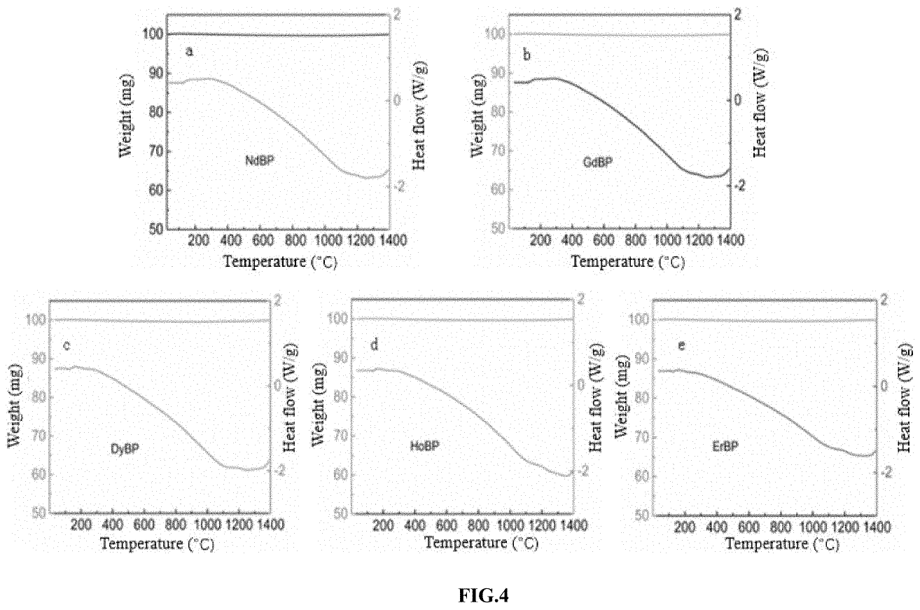

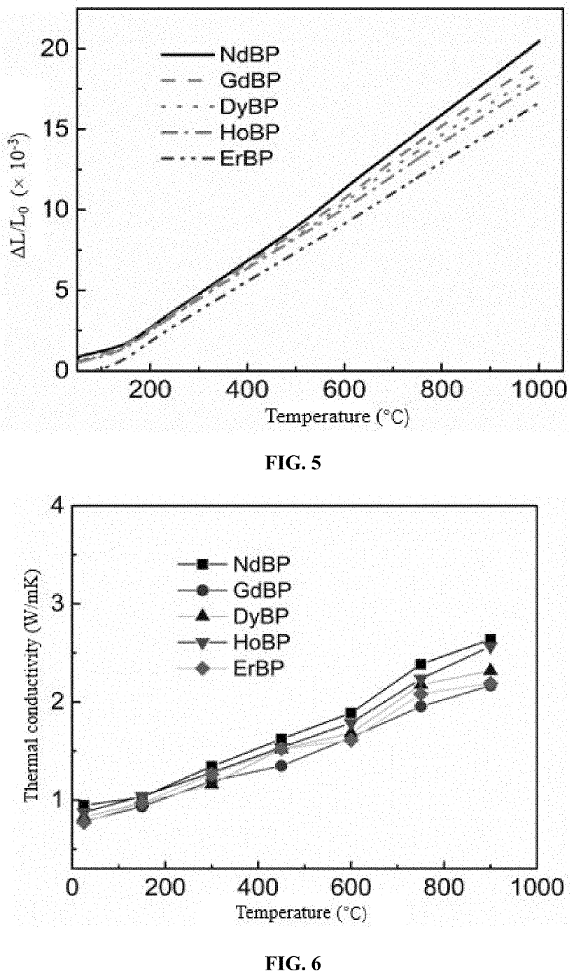

2. The hardness of the thermal barrier coating materials ReM₃P₃O₁₂ of Examples 1-5 is shown in FIG. 2; the modulus of elasticity is shown in FIG. 3; the TG-DTA curve is shown in FIG. 4; the coefficient of thermal expansion is shown in FIG. 5; and the thermal conductivity is shown in FIG. 6.

What is claimed is:

1. An orthophosphate thermal barrier coating material with high coefficient of thermal expansion, having a general chemical formula of ReM₃P₃O₁₂, which belongs to a −43 m space group of a cubic crystal system with an eulytite crystal structure, wherein Re is a rare earth element, and M is an alkaline earth metal.

2. The orthophosphate thermal barrier coating material with high coefficient of thermal expansion according to claim 1, wherein Re is one or two or a combination of more than two of Y, La, Nd, Sm, Gd, Dy, Ho, Er or Yb, and M is one or two or a combination of more than two of Sr, Ca or Ba.

3. The orthophosphate thermal barrier coating material with high coefficient of thermal expansion according to claim 1, wherein the orthophosphate thermal barrier coating material is selected from one of NdBa₃P₃O₁₂, GdBa₃P₃O₁₂, DyBa₃P₃O₁₂, HoBa₃P₃O₁₂, or ErBa₃P₃O₁₂.

4. A method for preparing the orthophosphate thermal barrier coating material with high coefficient of thermal expansion according to claim 1, wherein comprising the following steps:
(1) Mixing a rare earth oxide, an alkaline earth metal-containing compound and a P-containing compound uniformly according to a molar ratio of 1:(4-8):(4-8), placing in a muffle furnace, heating up to 1000° C.-1100° C., and maintaining a constant temperature to perform a first sintering for 4-6 h to obtain a pre-sintered raw material;
(2) Grinding and pressing the pre-sintered raw material, placing in the muffle furnace, heating up to 1300° C.-1500° C., and performing a second sintering to obtain a pure phase material;
(3) Adding the pure phase material to absolute ethanol, ball milling for 20-30 h using a wet ball milling method, then drying; grinding, sieving, and pressing into a green body;
(4) Placing the green body in the muffle furnace, heating up to 1500° C.-1700° C., performing a high-temperature reaction in an air atmosphere, and cooling down with the furnace after the reaction is completed to obtain an orthophosphate thermal barrier coating material with high coefficient of thermal expansion.

5. The preparation method according to claim 4, wherein in step (1), the molar ratio of the rare earth oxide, the alkaline earth metal-containing compound and the P-containing compound is 1:6:6.

6. The preparation method according to claim 4, wherein in step (1), the rare earth oxide is one or two or a combination of more than two of Y₂O₃, La₂O₃, Nd₂O₃, Sm₂O₃, Gd₂O₃, Dy₂O₃, Ho₂O₃, Er₂O₃ or Yb₂O₃; the purity of the rare earth oxide is greater than 99.99%, the alkaline earth metal-containing compound is one or two or a combination of more than two of BaCO₃ or SrCO₃ or BaCO₃, and the P-containing compound is ammonium dihydrogen phosphate.

7. The preparation method according to claim 4, wherein in step (1), the particle sizes of rare earth oxides, carbonates, and ammonium dihydrogen phosphate are 50-100 μm, the first sintering temperature is 1000° C., the time for maintaining the constant temperature is 5 h, and the heating rate of the first sintering is 8-12° C./min.

8. The preparation method according to claim 4, wherein in step (2), the second sintering temperature is 1400° C., the time for maintaining the constant temperature is 5 h, and the heating rate of the second sintering is 8-12° C./min.

9. The preparation method according to claim 4, wherein in step (3), the mass ratio of the added amount of absolute ethanol to the pure phase material is 1: (2-6), and the pressure for pressing into a green body is 200-350 MPa.

10. The preparation method according to claim 4, wherein in step (4), the high-temperature reaction temperature is 1600-1700° C., the heating rate is 1-3° C./min, and the high-temperature reaction time is more than or equal to 5 h; preferably, the high-temperature reaction time is 8-20 h.
